(19) United States
(12) Patent Application Publication
(10) Pub. No.: US 2026/0111369 A1
(43) Pub. Date: Apr. 23, 2026

(54) METHOD FOR PERFORMING ACCESS CONTROL OF MEMORY DEVICE WITH AID OF EXPANDER ARCHITECTURE, AND ASSOCIATED APPARATUS

(71) Applicant: Silicon Motion, Inc., Hsinchu County (TW)

(72) Inventor: Tsung-Chieh Yang, Hsinchu City (TW)

(73) Assignee: Silicon Motion, Inc., Hsinchu County (TW)

(21) Appl. No.: 19/196,719

(22) Filed: May 1, 2025

Related U.S. Application Data
(60) Provisional application No. 63/710,591, filed on Oct. 22, 2024.

(51) Int. Cl. G06F 13/16; G06F 11/10; G06F 13/40

(52) U.S. Cl. CPC G06F 13/1615; G06F 11/1068; G06F 13/1673; G06F 13/4022

(57) ABSTRACT

A method for performing access control of a memory device with aid of expander architecture and associated apparatus are provided, where the memory device may include a memory controller and a non-volatile (NV) memory. The method may include: sending at least one command from the memory controller to the NV memory through an input-output-expander (IO-expander) circuit, with the IO-expander circuit being coupled between the memory controller and the NV memory, in order to start performing at least one access operation on the plurality of NV memory elements via multiple channels, respectively; and during performing any access operation among the at least one access operation, utilizing the IO-expander circuit to expand IO control of the memory controller over the NV memory, for accessing at least one NV memory element corresponding to any sub-channel among a plurality of sub-channels, the plurality of sub-channels split from a single channel among the multiple channels.

### CROSS REFERENCE TO RELATED APPLICATIONS

This application claims the benefit of U.S. Provisional Application No. 63/710,591, filed on Oct. 22, 2024. The content of the application is incorporated herein by reference.

### BACKGROUND OF THE INVENTION

### 1. Field of the Invention

The present invention relates to memory control, and more particularly, to a method for performing access control of a memory device with aid of expander architecture, and associated apparatus such as the memory device, an electronic device comprising the memory device, a memory controller within the memory device, and an expander circuit within the memory device.

### 2. Description of the Prior Art

A memory device may comprise flash memory for storing data, and the management of accessing the flash memory is complicated. For example, the memory device may be a memory card, a solid state drive (SSD), or an embedded storage device such as that conforming to Universal Flash Storage (UFS) specification. The memory device may be arranged to store various files such as system files, user files, etc. in a file system of a host. When it is needed to design a SSD having a large capacity, there may be a large amount of logical unit numbers (LUNs) (e.g., 1024 LUNs) in the SSD architecture, and some issues may arise in the internal circuitry of the SSD, causing poor overall performance which is typically unacceptable to the users. Thus, a novel method and associated architecture are needed for solving the problems without introducing any side effect or in a way that is less likely to introduce a side effect.

### SUMMARY OF THE INVENTION

It is an objective of the present invention to provide a method for performing access control of a memory device with aid of expander architecture, and associated apparatus such as the memory device, an electronic device comprising the memory device, a memory controller within the memory device, and an expander circuit within the memory device, in order to solve the above-mentioned problems.

At least one embodiment of the present invention provides a method for performing access control of a memory device with aid of expander architecture, where the method can be applied to at least a memory controller within the memory device. The memory device may comprise the memory controller and a non-volatile (NV) memory, and the NV memory may comprise a plurality of NV memory elements. The method may comprise: sending at least one command from the memory controller to the NV memory through an input-output-expander (IO-expander) circuit, with the IO-expander circuit being coupled between the memory controller and the NV memory, in order to start performing at least one access operation on the plurality of NV memory elements via multiple channels, respectively; and during performing any access operation among the at least one access operation, utilizing the IO-expander circuit to expand IO control of the memory controller over the NV memory, for accessing at least one NV memory element corresponding to any sub-channel among a plurality of sub-channels, the plurality of sub-channels split from a single channel among the multiple channels under control of the IO-expander circuit.

In addition to the above method, the present invention also provides the IO-expander circuit that operates according to the method, where regarding the single channel, the IO-expander circuit comprises at least one one-to-many interface sub-circuit. In addition, any one-to-many interface sub-circuit among the at least one one-to-many interface sub-circuit may comprise two sets of channel buffers and two sets of sub-channel buffers. For example, the two sets of channel buffers may be arranged to buffer information on the single channel, wherein among the two sets of channel buffers, a set of channel buffers corresponding to a downlink direction are arranged to buffer transferred data from the memory controller, and a set of channel buffers corresponding to an uplink direction are arranged to buffer transferred data toward the memory controller; and the two sets of sub-channel buffers may be arranged to buffer information on a set of sub-channels among the plurality of sub-channels, wherein among the two sets of sub-channel buffers, a set of sub-channel buffers corresponding to the downlink direction are arranged to buffer transferred data toward multiple NV memory element groups corresponding to the set of sub-channels, and a set of sub-channel buffers corresponding to the uplink direction are arranged to buffer transferred data from the multiple NV memory element groups corresponding to the set of sub-channels.

In addition to the above method, the present invention also provides a memory controller for performing access control of a memory device with aid of expander architecture, where the memory device comprises the memory controller and an NV memory, and the NV memory may comprise a plurality of NV memory elements. In addition, the memory controller comprises a processing circuit that is arranged to control the memory controller according to a plurality of host commands from a host device, to allow the host device to access the NV memory through the memory controller. More particularly, the memory controller is arranged to send at least one command from the memory controller to the NV memory through an input-output-expander (IO-expander) circuit, with the IO-expander circuit being coupled between the memory controller and the NV memory, in order to start performing at least one access operation on the plurality of NV memory elements via multiple channels, respectively; and during performing any access operation among the at least one access operation, the memory controller is arranged to utilize the IO-expander circuit to expand IO control of the memory controller over the NV memory, for accessing at least one NV memory element corresponding to any sub-channel among a plurality of sub-channels, the plurality of sub-channels split from a single channel among the multiple channels under control of the IO-expander circuit.

In addition to the method mentioned above, the present invention also provides the memory device comprising the memory controller mentioned above, wherein the memory device comprises: the NV memory, configured to store information; the memory controller, configured to control operations of the memory device; and the IO-expander circuit, coupled between the memory controller and the NV memory, configured to expand the IO control of the memory controller over the NV memory.

In addition to the method mentioned above, the present invention also provides an electronic device comprising the memory device mentioned above, wherein the electronic device further comprises the host device that is coupled to the memory device. The host device may comprise: at least one processor, arranged for controlling operations of the host device; and a power supply circuit, coupled to the at least one processor, arranged for providing power to the at least one processor and the memory device. In addition, the memory device provides the host device with storage space.

According to some embodiments, the apparatus may comprise at least one portion (e.g., a portion or all) of the electronic device. For example, the apparatus may comprise the memory controller within the memory device. In another example, the apparatus may comprise the memory device. In yet another example, the apparatus may comprise the electronic device.

The method of the present invention and the associated apparatus can guarantee that the memory device can operate properly in various situations. For example, the memory controller within the memory device can operate according to at least one control scheme (e.g., one or more control schemes) of the method to perform associated operations, and more particularly, can access the NV memory through the IO-expander circuit rather than accessing the NV memory directly, to limit the number of loads at a single channel NAND bus of the memory controller and prevent the direct memory access (DMA) speed between the memory controller and the NV memory from being decreased due to increased capacitance corresponding to an increased number of loads. In addition, the method of the present invention and the associated apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 illustrates an interfacing control scheme of a method for performing access control of a memory device with aid of expander architecture according to an embodiment of the present invention.

FIG. 3 illustrates, in the lower half part thereof, a hybrid packaging control scheme of the method according to an embodiment of the present invention, where some other packaging control schemes are illustrated in the upper half part of FIG. 3 for better comprehension.

FIG. 4 illustrates an expander control scheme of the method according to an embodiment of the present invention.

FIG. 5 illustrates some implementation details of the expander control scheme shown in FIG. 4 according to an embodiment of the present invention.

FIG. 6 illustrates a monitoring and switching control scheme of the method according to an embodiment of the present invention.

FIG. 7 illustrates a working flow of the method according to an embodiment of the present invention.

### DETAILED DESCRIPTION

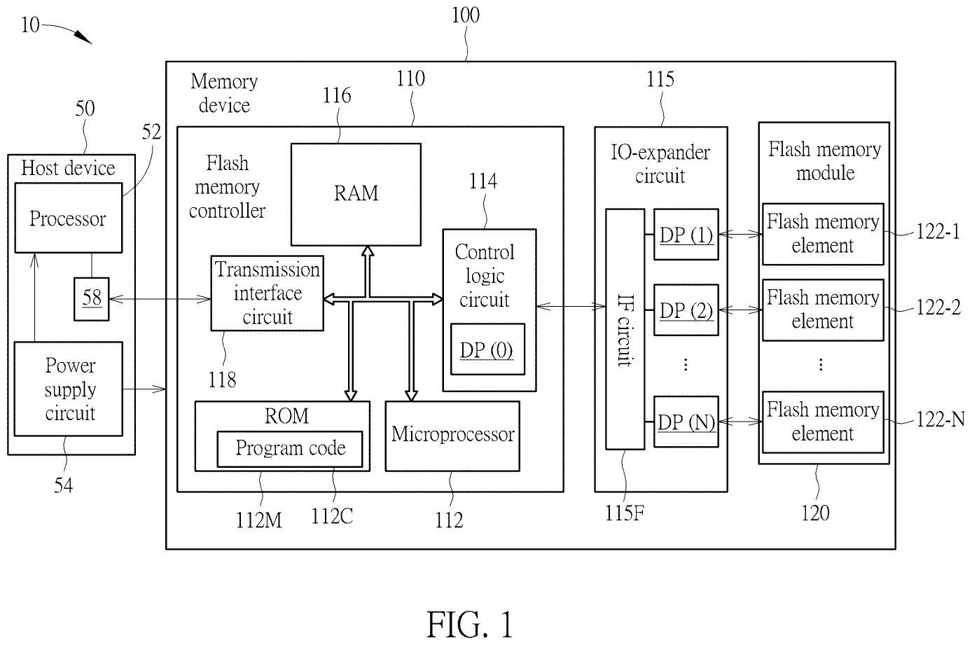

FIG. 1 is a diagram of an electronic device according to an embodiment of the present invention. The electronic device 10 may comprise a host device 50 and the memory device 100. The host device 50 may comprise at least one processor (e.g., one or more processors) which may be collectively referred to as the processor 52, and may further comprise a power supply circuit 54 coupled to the processor 52. The processor 52 is arranged for controlling operations of the host device 50, and the power supply circuit 54 is arranged for providing power to the processor 52 and the memory device 100, and outputting one or more driving voltages to the memory device 100. The memory device 100 may be arranged for providing the host device 50 with storage space, and obtaining the one or more driving voltages from the host device 50 as power source of the memory device 100. Examples of the host device 50 may include, but are not limited to: a multifunctional mobile phone, a wearable device, a tablet computer, a personal computer such as a desktop computer and a laptop computer. Examples of the memory device 100 may include, but are not limited to: a solid state drive (SSD), and various types of embedded memory devices such as that conforming to Peripheral Component Interconnect Express (PCIe) specification, etc. According to this embodiment, the memory device 100 may comprise a memory controller such as a flash memory controller 110 as well as an input/output (I/O) expander circuit such as an input-output-expander (IO-expander) circuit 115, and may further comprise an NV memory such as a flash memory, and the flash memory may be implemented as a flash memory module 120, where the flash memory controller 110 is arranged to control operations of the memory device 100 and access the flash memory module 120, and the flash memory module 120 is arranged to store information. The NV memory such as the flash memory module 120 may comprise a plurality of NV memory element such as a plurality of flash memory elements 122-1, 122-2 . . . and 122-N, where “N” may represent a positive integer that is greater than one. For example, the plurality of flash memory elements 122-1, 122-2 . . . and 122-N may be implemented by way of flash memory chips, flash memory dies, etc. According to some embodiments, the plurality of flash memory elements 122-1, 122-2 . . . and 122-N may be implemented as a plurality of flash memory dies that are packed, stacked and/or integrated into at least one flash memory chip (e.g., one or more flash memory chips), where any flash memory chip among the aforementioned at least one flash memory chip may comprise at least one flash memory dies among the plurality of flash memory dies.

As shown in FIG. 1, the flash memory controller 110 may comprise a processing circuit such as a microprocessor 112, a storage unit such as a read-only memory (ROM) 112M, a control logic circuit 114, a random-access memory (RAM) 116 and a transmission interface circuit 118, where the above components may be coupled to one another via a bus. The RAM 116 is implemented by a Static RAM (SRAM), but the present invention is not limited thereto. The RAM 116 may be arranged to provide the flash memory controller 110 with internal storage space. For example, the RAM 116 may be utilized as a buffer memory for buffering data. In addition, the ROM 112M of this embodiment is arranged to store a program code 112C, and the microprocessor 112 is arranged to execute the program code 112C to control the access of the flash memory module 120. In some examples, the program code 112C may be stored in the RAM 116 or any type of memory. Further, the control logic circuit 114 may be arranged to control the flash memory module 120, and may comprise a data protection circuit DP(0) for performing data protection processing operations. For example, the data protection circuit DP(0) may represent a Cyclic redundancy check (CRC) circuit, for protecting data and/or performing re-transmission control for the flash memory controller 110. The transmission interface circuit 118 may conform to one or more communications specifications among various communications specifications (e.g., Serial Advanced Technology Attachment (Serial ATA, or SATA) specification, Universal Serial Bus (USB) specification, Peripheral Component Interconnect (PCI) specification, Peripheral Component Interconnect Express (PCIe) specification, embedded Multi Media Card (eMMC) specification, and Universal Flash Storage (UFS) specification), and may perform communications with the host device 50 (or a corresponding transmission interface circuit therein such as the transmission interface circuit 58) according to the one or more communications specifications for the memory device 100. Similarly, the transmission interface circuit 58 may conform to the one or more communications specifications, and may perform communications with the memory device 100 (or the transmission interface circuit 118 therein) according to the one or more communications specification for the host device 50.

When the memory device 100 is designed to having a large capacity, there may be a large amount of LUNs (e.g., 1024 LUNs) in the memory device architecture, and the total amount of the LUNs may be equal to the flash memory element count N of the plurality of flash memory elements 122-1, 122-2 . . . and 122-N. When N=1024, electrically connecting the flash memory controller 110 and the flash memory module 120 to each other directly may lead to some issues in the internal circuitry of the memory device 100, causing poor overall performance which is typically unacceptable to the users. While such direct connection is impractical, utilizing the IO-expander circuit 115 to expand the IO control of the flash memory controller 110 is very helpful on enhancing the overall performance. As shown in FIG. 1, the IO-expander circuit 115 may comprise an interface (IF) circuit 115F, for performing interfacing operations such as command monitoring, signal amplification, transmission flow arbitrating, signal multiplexing and de-multiplexing, etc., and further comprise at least one data protection circuit (e.g., one or more data protection circuits) such as the data protection circuits DP(1), DP(2), . . . and DP(N), for performing data protection processing operations. For example, the aforementioned at least one data protection circuit such as the data protection circuits DP(1), DP(2), . . . and DP(N) can be implemented by way of at least one digital signal processing (DSP) engine, at least one encoder and decoder circuit, etc., but the present invention is not limited thereto. According to some embodiments, any encoder and decoder circuit among the aforementioned at least one encoder and decoder circuit may comprise an encoder and a decoder arranged to perform encoding and decoding operations, respectively. The encoding and decoding operations of the encoder and the decoder may comprise ECC encoding and ECC decoding, for protecting data and/or perform error correction for any sub-storage-unit of multiple sub-storage-units within a physical page. For example, the aforementioned at least one encoder and decoder circuit may be implemented as at least one low-density parity-check (LDPC) code circuit, and the encoding/decoding thereof may comprise LDPC code encoding/decoding.

In this embodiment, the host device 50 may transmit host commands and corresponding logical addresses to the flash memory controller 110 to access the memory device 100. The flash memory controller 110 receives the host commands and the logical addresses, and translates the host commands into memory operating commands (which may be simply referred to as operating commands), and further controls the flash memory module 120 with the operating commands through the IO-expander circuit 115 to perform reading, writing/programing, etc. on memory units (e.g., data pages) having physical addresses within the flash memory module 120, where the physical addresses can be associated with the logical addresses. When the flash memory controller 110 performs an erase operation on any flash memory element 122-n among the plurality of flash memory elements 122-1, 122-2 . . . and 122-N (in which “n” may represent any integer in the interval [1, N]), at least one block of multiple blocks of the flash memory element 122-n may be erased, where each block of the blocks may comprise multiple pages (e.g., data pages), and an access operation (e.g., a reading operation or a writing operation) may be performed on one or more pages.

Regarding internal management of the memory device 100, the flash memory controller 110 can record, maintain, and/or update management information in at least one table such as at least one temporary table (e.g. one or more temporary tables) in the RAM 116 and at least one non-temporary table (e.g. one or more non-temporary tables) in the flash memory module 120, where the aforementioned at least one temporary table can be collectively referred to as the temporary table, and the aforementioned at least one non-temporary table can be collectively referred to as the non-temporary table. The temporary table may comprise a temporary version of at least a portion (e.g. a part or all) of the non-temporary table. For example, the non-temporary table may comprise at least one logical-to-physical (L2P) address mapping table (e.g. one or more L2P address mapping tables), for recording mapping relationships between multiple logical addresses (e.g. logical block addresses (LBAs) indicating multiple logical blocks, and logical page addresses (LPAs) indicating multiple logical pages within any of the multiple logical blocks) and multiple physical addresses (e.g. physical block addresses (PBAs) indicating multiple physical blocks, and physical page addresses (PPAs) indicating multiple physical pages within any of the multiple physical blocks), and the temporary table may comprise a temporary version of at least one sub-table (e.g. one or more sub-tables) of the aforementioned at least one L2P address mapping table, where the flash memory controller 110 (e.g. the microprocessor 112) can perform bi-directional address translation between the host-side storage space (e.g. the logical addresses) of the host device 50 and the device-side storage space (e.g. the physical addresses) of the flash memory module 120 within the memory device 100, in order to access data for the host device 50.

In the flash memory module 120, when a block of any one of the flash memory elements 122-1, 122-2, . . . and 122-N serves as a single level cell (SLC) block, each of the physical pages within the block may correspond to one logical page, and each of the memory cells of the page may be configured to store only one bit. In addition, when a block of any one of the flash memory elements 122-1, 122-2, . . . and 122-N serves as a multiple level cell (MLC) block, each of the physical pages within the block may correspond to at least two logical pages, and each of the memory cells of the page may be configured to store at least two bits. More particularly, when a block of any one of the flash memory elements 122-1, 122-2, . . . and 122-N serves as a triple level cell (TLC) block, each of the physical pages within the block may correspond to three logical pages, and each of the memory cells of the page may be configured to store three bits; when a block of any one of the flash memory elements 122-1, 122-2, . . . and 122-N serves as a quadruple level cell (QLC) block, each of the physical pages within the block may correspond to four logical pages, and each of the memory cells of the page may be configured to store four bits; and the rest can be deduced by analogy.

TABLE 1

| | | 16-Ch | | |
|---|---|---|---|---|
| | Total | model's | | |
| | LUN in | per | | |
| | whole | channel | ODP, 2 Ch, | HDP, 2 Ch, |
| | drive | LUN | 4 LUN per Ch | 8 LUN per Ch |
| 128 TB | 1024 | 64 LUNs | Drive: 128 ODPs | Drive: 64 HDPs |
| TLC drive | LUNs | per Ch | Per-Ch: 16 ODPs | Per-Ch: 8 HDPs |
| 128 TB | 512 | 32 LUNs | Drive: 64 ODPs | Drive: 32 HDPs |
| QLC drive | LUNs | per Ch | Per-Ch: 8 ODPs | Per-Ch: 4 HDPs |
| 256 TB | 2048 | 128 LUNs | Drive: 256 ODPs | |
| TLC drive, | LUNs | per Ch | Per-Ch: 32 ODPs | |
| 128 GB | | | | |
| per LUN | | | | |
| 256 TB | 1024 | 64 LUNs | Drive: 128 ODPs | |
| QLC drive | LUNs | per Ch | Per-Ch: 16 ODPs | |

Table 1 illustrates multiple sets of configurations that are applicable to the memory device 100 according to some embodiments of the present invention, respectively. The memory device 100 may act as any drive among a 128 terabytes (TB) TLC drive, a 128 TB QLC drive, a 256 TB TLC drive with 128 gigabytes (GB) per LUN, and a 256 TB QLC drive, depending on the corresponding set of configurations among the multiple sets of configurations, and any set of configurations among the multiple sets of configurations may comprise the Total LUNs in the whole drive, the 16-channel (16-Ch) model's per channel LUNs, the number of 8-die packages (ODPs) of the 2-channel type (or “2 Ch”) with 4 LUNs per channel (Ch), and the number of 16-die package (HDPs) of the 2-channel type with 8 LUNs per channel. For better comprehension, assuming that the IO-expander circuit 115 may be temporarily omitted in the architecture of the memory device 100, when using the direct connection mentioned above, there will be a 256 TB/128 TB disk challenge, and this is the issue to support 1024Die/512Die per drive:
(a) Single LUN (or die) capacity changes become slow;
(b) Current main capacity per LUN (or die) is 1 terabit (Tb) for TLC, and 2 Tb for QLC, and it will be 128 GB to 256 GB;
(c) ODPs, with 8 LUNs/dies per package, normally support two channels, and the module maker (e.g., the manufacturer of the flash memory module 120 and/or the memory device 100) is typically much easier to buy this kinds of samples; and
(d) HDPs, with 16 LUNs/dies per package, normally support two or four channels; and
(e) 32-die packages (32DPs), with 32 LUNs/dies per package, may be very few.

The method of the present invention and the associated apparatus such as the architecture shown in FIG. 1 can solve the related art problems without introducing any side effect or in a way that is less likely to introduce a side effect.

Based on the architecture shown in FIG. 1, assuming that “K” and “M” can be positive integers and that the flash memory element count N mentioned above can be equal to (K*M), the flash memory controller 110 can perform access operations (e.g., reading operations or writing operations) on the flash memory elements 122-1, 122-2 . . . and 122-N such as N NAND flash dies via K channels such as 16 channels, respectively, where there are M flash memory elements such as M NAND flash dies per channel. When the flash memory element count N and the channel count K are known (or determined), the per-channel flash memory element count can be obtained from dividing the flash memory element count N by the channel count K. For example, if N=1024 and K=16, it can be determined that M=64, indicating that there are 64 flash memory elements such as 64 NAND flash dies per channel, and the rest can be deduced by analogy. In addition, the IO-expander circuit 115 comprises K interface sub-circuits corresponding to the K channels, for accessing K sets of flash memory elements on the K channels, respectively, and any interface sub-circuit among the K interface sub-circuits comprises multiple one-to-many interface sub-circuits corresponding to multiple branches of circuits (or “the branches”), such as X one-to-L (1-to-L) interface sub-circuits corresponding to X branches, with the per-channel branch count X and the per-branch sub-channel count L being positive integers greater than one.

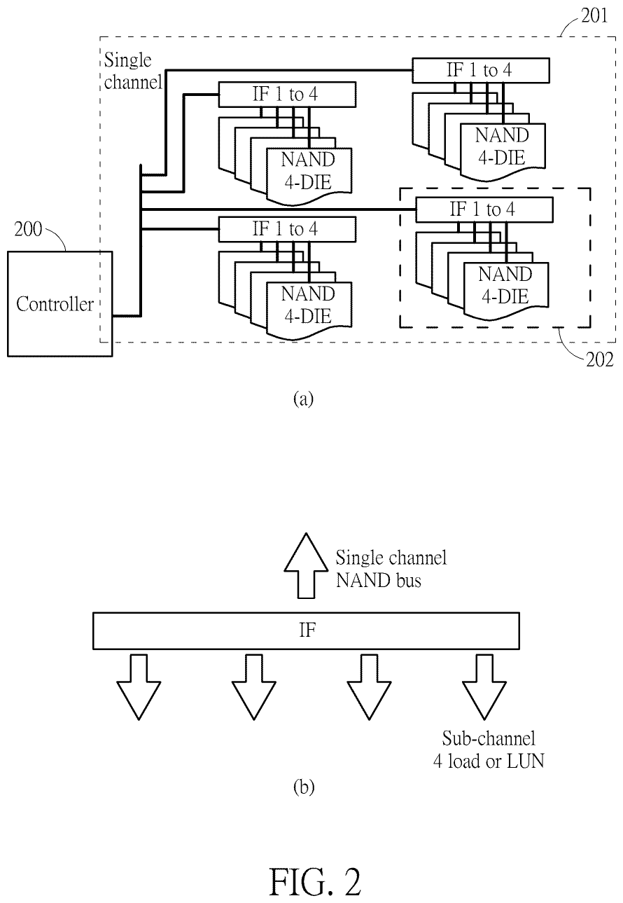

FIG. 2 illustrates an interfacing control scheme of a method for performing access control of a memory device (e.g., the memory device 100 shown in FIG. 1) with aid of expander architecture according to an embodiment of the present invention. The flash memory controller 110 in the architecture shown in FIG. 1, such as the controller 200 shown in the sub-diagram (a) of FIG. 2, can perform access operations (e.g., reading operations or writing operations) on the M flash memory elements such as 64 NAND flash dies on one of the K channels through the corresponding 1-to-L interface sub-circuits such as the corresponding one-to-four (1-to-4) interface sub-circuits (labeled “IF 1 to 4” for brevity). The 1-to-L interface sub-circuits can perform communication operations with the controller 200 via a single channel NAND bus (which can be illustrated as the L shape bold line from the controller 200 as shown in the sub-diagram (a)), and perform communication operations with the M flash memory elements such as the 64 NAND flash dies via (X*L) sub-channels such as 16 sub-channels, respectively. For example, any sub-channel among the (X*L) sub-channels can be configured for coupling (M/(X*L)) loads (or (M/(X*L)) LUNs/dies).

Assuming that a single channel 201 (e.g., any channel among the K channels) with four loads still can achieve the highest IO-speed, the single channel 201 may need 64 dies with two stage IF-chip connections, and any branch among the four branches on the single channel 201 may comprise a 1-to-4 interface sub-circuit and the associated NAND flash dies. Taking the branch 202 as an example, by using the 1-to-4 interface sub-circuit thereof, four groups of NAND flash dies (or “the four NAND flash die groups”) can be coupled to the controller 200, respectively, where any NAND flash die group among the four NAND flash die groups comprises four NAND flash dies (labeled “NAND 4-DIE” for brevity). In addition, the single channel 201 may be a single channel with 20 bits, and the associated signal such as the Data Strobe (DQS) signal, the Data (DQ) signals, the Read Enable (RE) signal, the Write Enable (WE) signal, etc. may need special taking care. As shown in the sub-diagram (b), for any 1-to-4 interface sub-circuit among the respective 1-to-4 interface sub-circuits of the four branches on the single channel 201, such as a single interface-chip/die (labeled “IF” for brevity) with one up-link/uplink (e.g., the uplink toward the controller 200) and four down-links/downlinks (e.g., the downlinks toward the NAND flash dies), there will be one hundred single pins (e.g., 20 pins, for the 20 bits corresponding to the one uplink, plus 80 pins, for the (20*4) bits corresponding to the four downlinks), and total 150 ball out. The 1-to-4 interface sub-circuit (or the IF) can perform communication operations with the controller 200 via the single channel NAND bus, and perform communication operations with the four NAND flash die groups via the four sub-channels, respectively. For example, any sub-channel among the four sub-channels can be configured for coupling four loads (or four LUNs/dies). More control schemes of the method will be described in the subsequent embodiments.

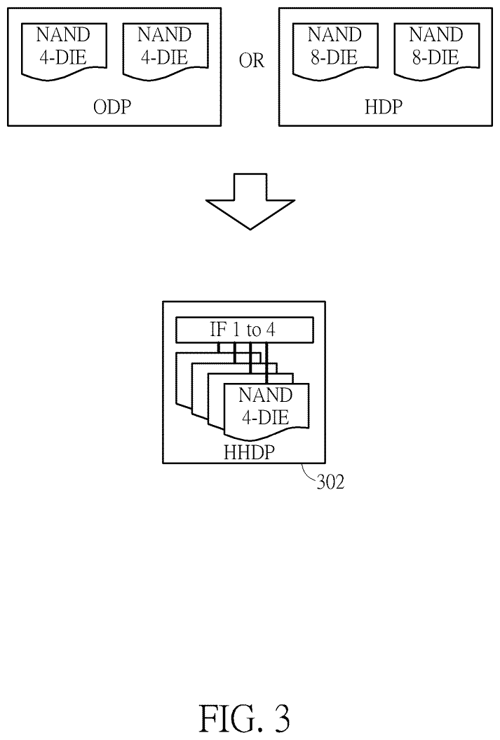

FIG. 3 illustrates, in the lower half part thereof, a hybrid packaging control scheme of the method according to an embodiment of the present invention, where some other packaging control schemes are illustrated in the upper half part of FIG. 3 for better comprehension. Assuming that the module maker can buy the ODP shown in the upper half part of FIG. 3, the ODP can be arranged to have two NAND flash die groups packed therein, with each NAND flash die group comprising four NAND flash dies (labeled “NAND 4-DIE” for brevity), and there will be a large amount of interconnections. The HDP can be arranged to have two NAND flash die groups packed therein, with each NAND flash die group comprising eight NAND flash dies (labeled “NAND 8-DIE” for brevity), and therefore can help to reduce the interconnections, but there is still a significant amount of interconnections. Therefore, the packaging control schemes corresponding to the ODP and the HDP do not work when there is a large amount of LUNs (e.g., 1024 LUNs) in the memory device architecture of the memory device 100. Based on the hybrid packaging control scheme, a special package can be arranged to include the 1-to-4 interface sub-circuit and the associated NAND flash dies within the aforementioned any branch (e.g., the branch 202) among the four branches on the single channel 201, and more particularly, can be implemented as a hybrid HDP (HHDP) 302 to have the 1-to-4 interface sub-circuit (labeled “IF 1 to 4” for brevity) such as a single IF-chip/die plus four NAND flash die groups packed therein, with each NAND flash die group comprising four NAND flash dies (labeled “NAND 4-DIE” for brevity). For example, the respective NAND flash dies of the four NAND flash die groups can be implemented as a set of 16 stacked NAND flash dies.

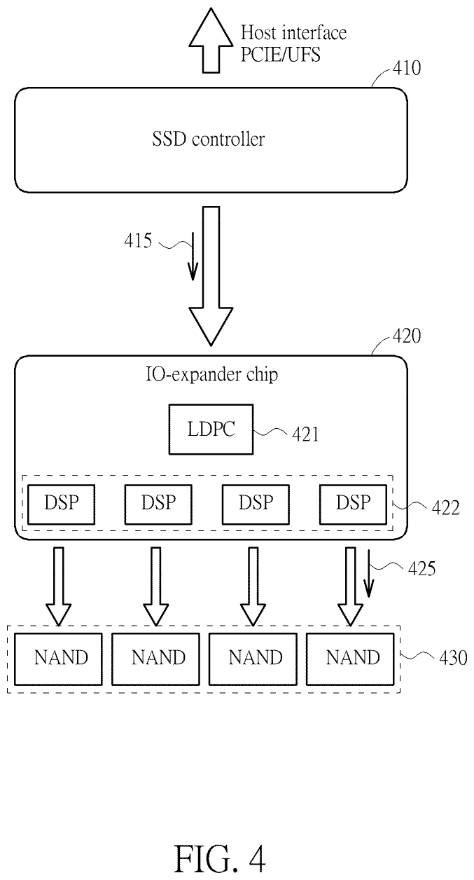

FIG. 4 illustrates an expander control scheme of the method according to an embodiment of the present invention. The SSD controller 410, the IO-expander chip 420, and the four NAND flash die groups 430 (labeled “NAND” for brevity) can be taken as examples of the controller 200, the 1-to-4 interface sub-circuit of the aforementioned any branch (e.g., the branch 202) among the four branches on the single channel 201, and the associated NAND flash dies of the same branch (e.g., the branch 202) within the architecture shown in FIG. 2, respectively. The SSD controller 410 can be coupled to the host interface (e.g., the transmission interface circuit 18 shown in FIG. 1) conforming to the one or more communications specifications such as the PCIe specification, the UFS specification, etc. (labeled “Host interface PCIE/UFS” for brevity). For example, the IO-expender chip 420 is pad-limited. The SSD controller 410 can be configured to connect to the IO-expander chip 420. Based on the expander control scheme, as the IO-expender chip 420 comprises many terminals (e.g., the terminals for communicating with the SSD controller 410 and the terminals for communicating with the four NAND flash die groups 430), occupying the boundary sub-areas within the chip area of the IO-expender chip 420, it is preferred to put the LDPC coder and decoder (LDPC-codec) and/or the DSP engine into the IO-expender chip 420, and more particularly, implement the IO-expander chip 420 to comprise both of the LDPC-codec 421 (labeled “LDPC” for brevity) and the DSP engines 422 (e.g., the DSP engines 422 respectively corresponding to the four sub-channels), in order to fully utilize the central sub-area within the chip area of the IO-expender chip 420, rather than leaving the central sub-area to be unused or inefficiently used.

During a writing operation that is performed on the aforementioned any NAND flash die group (or one or more NAND flash dies thereof) among the four NAND flash die groups 430 by the SSD controller 410 via the IO-expender chip 420, the transferred data 415 from the SSD controller 410 to the IO-expender chip 420 comprises a message but does not include any LDPC-parity, and therefore can save 15% overhead approximately in this embodiment. The SSD controller 410 can offload the LDPC-codec processing into the IO-expender chip 420 to make the IO-expender chip 420 handle the LDPC-codec processing such as the LDPC code encoding, in order to encode the message carried by the transferred data 415 to generate an LDPC-code encoding result of the message. As a result, the transferred data 425 from the IO-expender chip 420 to this NAND flash die group (or the one or more NAND flash dies thereof) comprises partial messages of the message and their LDPC-parities.

During a reading operation that is performed on the same NAND flash die group (or the one or more NAND flash dies thereof) by the SSD controller 410 via the IO-expender chip 420, the reverse transferred data of the transferred data 425, such as the transferred data with an opposite direction from this NAND flash die group (or the one or more NAND flash dies thereof) to the IO-expender chip 420, comprises the partial messages of the message and their LDPC-parities. The SSD controller 410 can offload the LDPC-codec processing into the IO-expender chip 420 to make the IO-expender chip 420 handle the LDPC-codec processing such as the LDPC code decoding, in order to decode the partial messages of the message and their LDPC-parities within the reverse transferred data of the transferred data 425 to generate an LDPC-code decoding result of the partial messages of the message and their LDPC-parities, such as the message. As a result, the reverse transferred data of the transferred data 415, such as the transferred data with an opposite direction from the IO-expender chip 420 to the SSD controller 410, comprises the message.

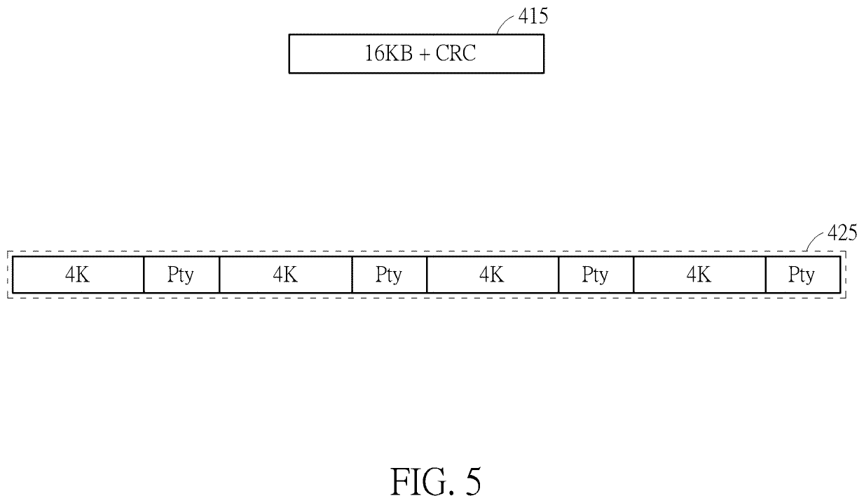

FIG. 5 illustrates some implementation details of the expander control scheme shown in FIG. 4 according to an embodiment of the present invention. Regarding the writing operation that is performed on the aforementioned any NAND flash die group (or the one or more NAND flash dies thereof) by the SSD controller 410 via the IO-expender chip 420, the transferred data 415 may comprise the message such as 16 kilobytes (KB) of data (or “the 16 KB data”) and a CRC code corresponding to the 16 KB data (labeled “16 KB+CRC” for brevity), having no need to include any LDPC-parity. The transferred data 425 may comprise the LDPC-code encoding result of the message (e.g., the 16 KB data), such as the partial messages (e.g., 4 KB of data or “the 4 KB data”) of the message followed by their LDPC-parities, respectively (labeled “4K” and “Pty” for brevity), for example, with the interface overhead of 15%. As the main interface overhead occurs at the transferred data 415 rather than the transferred data 425, when there is a large amount of LUNs (e.g., 1024 LUNs) in the memory device architecture of the memory device 100, the control logic circuit 114 (or the single channel NAND bus mentioned above) will not become a bottleneck.

Similarly, regarding the reading operation that is performed on the same NAND flash die group (or the one or more NAND flash dies thereof) by the SSD controller 410 via the IO-expender chip 420, the reverse transferred data of the transferred data 415 may comprise the message such as the 16 KB data and a CRC code (e.g., the same CRC code or another CRC code, depending on the CRC coding method used and/or selected by the IO-expender chip 420) corresponding to the 16 KB data. In addition, the reverse transferred data of the transferred data 425 may comprise the LDPC-code encoding result of the message (e.g., the 16 KB data), such as the partial messages (e.g., the 4 KB data) of the message followed by their LDPC-parities, respectively. For brevity, similar descriptions for this embodiment are not repeated in detail here.

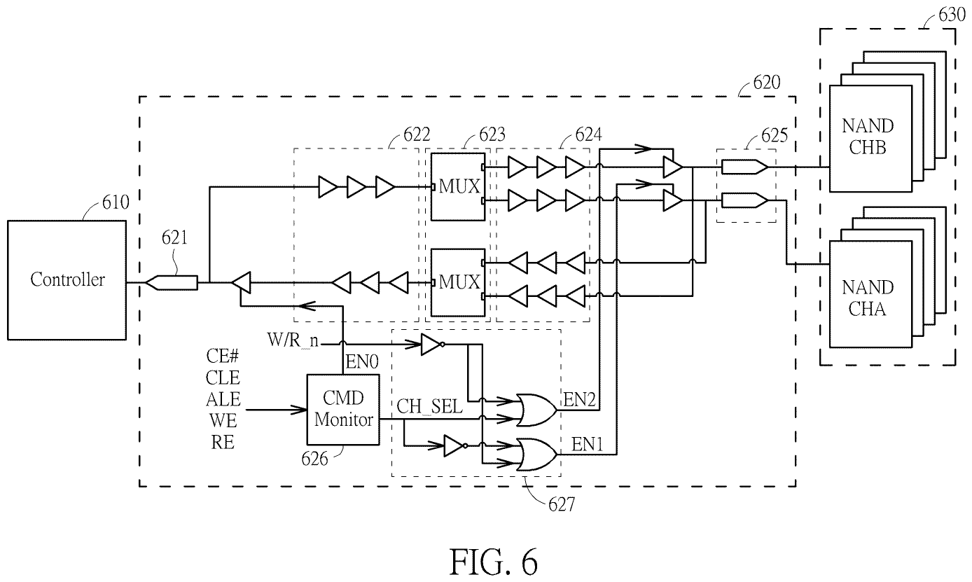

FIG. 6 illustrates a monitoring and switching control scheme of the method according to an embodiment of the present invention. The controller 610, the one-to-two (1-to-2) interface sub-circuit 620, and the two NAND flash die groups 630 corresponding to two sub-channels CHA and CHB (labeled “NAND CHA” and “NAND CHB” for brevity) at the NV memory side (or the flash memory side) can be taken as examples of the controller 200, any 1-to-L interface sub-circuit among the corresponding 1-to-L interface sub-circuits mentioned above, and all NV memory elements acting as the loads of the aforementioned any 1-to-L interface sub-circuit, respectively. Assuming that “CNT_bit” can be a positive integer greater than one and that any channel among the K channels is a single channel with CNT_bit bits, the 1-to-2 interface sub-circuit 620 may comprise CNT_bit terminals 621 on the single channel (e.g., 20 pins, for the 20 bits on the single channel in the case of CNT_bit=20), two sets of channel buffers 622 respectively corresponding to an uplink direction and a downlink direction, two set of multiplexer/demultiplexer (MUX/DEMUX) circuits 623 (labeled “MUX” for brevity) respectively corresponding to the uplink direction and the downlink direction, two sets of sub-channel buffers 624 respectively corresponding to the uplink direction and the downlink direction, and L sets of terminals 625 on L sub-channels, such as (CNT_bit*L) terminals 625 (e.g., 40 pins, for the (20*2) bits on the two sub-channels CHA and CHB in the case of CNT_bit=20 and L=2), a command (CMD) monitor circuit 626 (labeled “CMD Monitor” for brevity), a logic control circuit 627, and multiple enabling (ENB) circuits controlled by the enabling signals EN0, EN1 and EN2. In addition, the 1-to-2 interface sub-circuit 620 is coupled to the controller 610 through the CNT_bit terminals 621 (e.g., the 20 pins, if CNT_bit=20), and is coupled to L NAND flash die groups such as the two NAND flash die groups 630 through the (CNT_bit*L) terminals 625 (e.g., the 40 pins, if CNT_bit=20 and L=2). The single channel bit count CNT_bit of the single channel and the per-sub-channel bit count CNT_bit of any sub-channel among the L sub-channels (e.g., the two sub-channels CHA and CHB in the case of L=2) are equal to each other.

The two sets of channel buffers 622 can buffer information (e.g., the transferred data to/from the controller 610) on the single channel. Among the two sets of channel buffers 622, the set of channel buffers corresponding to the downlink direction (e.g., the rightward direction in FIG. 6), such as the upper set among the two sets of channel buffers 622, can buffer the transferred data from the controller 610, and the set of channel buffers corresponding to the uplink direction (e.g., the leftward direction in FIG. 6), such as the lower set among the two sets of channel buffers 622, can buffer the transferred data toward the controller 610. In addition, the two sets of sub-channel buffers 624 can buffer information (e.g., the transferred data to/from the L NAND flash die groups such as the two NAND flash die groups 630) on the L sub-channels such as the two sub-channels CHA and CHB. Among the two sets of sub-channel buffers 624, the set of sub-channel buffers corresponding to the downlink direction, such as the upper set among the two sets of sub-channel buffers 624, can buffer the transferred data toward the L NAND flash die groups such as the two NAND flash die groups 630, and the set of sub-channel buffers corresponding to the uplink direction, such as the lower set among the two sets of sub-channel buffers 624, can buffer the transferred data from the L NAND flash die groups such as the two NAND flash die groups 630. Additionally, the two sets of MUX/DEMUX circuits 623 can perform multiplexing or demultiplexing on incoming information thereof between the single channel and the L sub-channels such as the two sub-channels CHA and CHB. Among the two sets of MUX/DEMUX circuits 623, the set of DEMUX circuits corresponding to the downlink direction, such as the upper set among the two sets of MUX/DEMUX circuits 623, can perform demultiplexing on the single channel to obtain the incoming information (e.g., the message or its partial messages) from the single channel, for being output to a target sub-channel among the L sub-channels such as the two sub-channels CHA and CHB, and the set of MUX circuits corresponding to the uplink direction, such as the lower set among the two sets of MUX/DEMUX circuits 623, can perform multiplexing on the L sub-channels such as the two sub-channels CHA and CHB to obtain the incoming information (e.g., the message or its partial messages) from the target sub-channel, for being output to the single channel.

The command monitor circuit 626 can monitor or detect the associated signals from the controller 610, such as the Chip Enable (CE) signal corresponding to a chip number (labeled “CE #” for brevity), the Command Latch Enable (CLE) signal, the Address Latch Enable (ALE) signal, the WE signal, the RE signal, etc., in order to monitor various commands (e.g., commands conforming to one or more protocols) of the controller 610 to dynamically switch the bus direction within the 1-to-2 interface sub-circuit 620 correspondingly. More particularly, the command monitor circuit 626 can generate the enabling signal EN0, for controlling the corresponding enabling circuit (e.g., the enabling circuit between the two sets of channel buffers 622 and the CNT_bit terminals 621) to selectively enable the associated signal paths on the single channel, and can generate the channel selection signal CH_SEL as a reference signal for the logic control circuit 627. In addition, the logic control circuit 627 can refer to at least one signal among the channel selection signal CH_SEL and a Write/Read (W/R) signal corresponding to a target number (labeled “W/R_n” for brevity) to generate the enabling signals EN1 and EN2, for controlling the corresponding enabling circuits (e.g., the enabling circuits between the two sets of sub-channel buffers 624 and the (CNT_bit*L) terminals 625) to selectively enable the associated signal paths on the L sub-channels, respectively. This is for illustrative purposes only, and is not meant to be a limitation of the present invention. According to some embodiments, the internal circuitry of the 1-to-2 interface sub-circuit 620 may vary, and the associated internal control of the 1-to-2 interface sub-circuit 620 may vary correspondingly.

In the above embodiment, the 1-to-2 interface sub-circuit 620 and the two NAND flash die groups 630 in the architecture shown in FIG. 6 can be illustrated with the case of L=2, but the present invention is not limited thereto. As long as the implementation of the present invention will not be hindered, the 1-to-2 interface sub-circuit 620 and the two NAND flash die groups 630 in the architecture shown in FIG. 6 can be illustrated as becoming the 1-to-L interface sub-circuit and L NAND flash die groups, respectively, where the per-branch sub-channel count L can be equal to any value among various candidate values (e.g., positive integers greater than one) thereof. In addition, the buffers within the 1-to-2 interface sub-circuit 620, such as the two sets of channel buffers 622 and the two sets of sub-channel buffers 624, can be implemented by way of re-driver buffering. Additionally, the 1-to-2 interface sub-circuit 620 can forward the associated signals from the controller 610 to the target sub-channel, for expanding the IO-control from the controller 610 to the NAND flash die group on the target sub-channel. For example, the CLE signal and the ALE signal can be arranged for indicating the read operating command and the addresses to be latched on multiple I/O terminals (e.g., the I/O terminals for transmitting the DQ signals such as the data signals DQ [7:0] during data transfer), respectively.

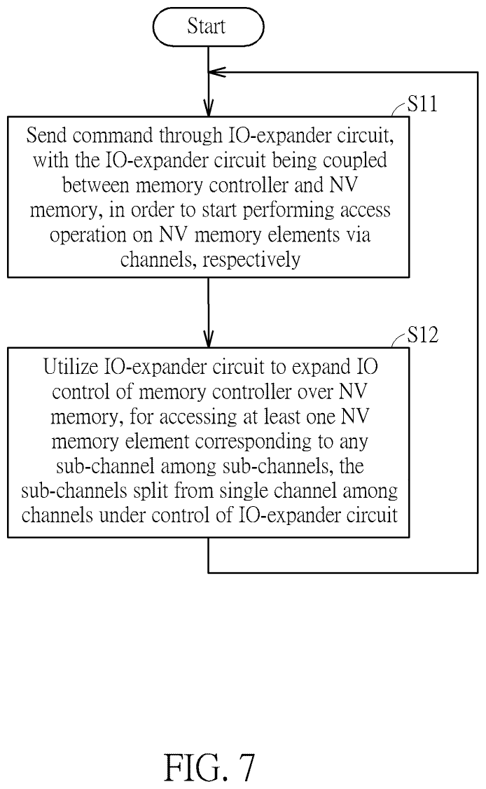

FIG. 7 illustrates a working flow of the method according to an embodiment of the present invention. The memory device 100 (or the flash memory controller 110 therein) can operate according to the working flow shown in FIG. 7, and more particularly, access the NV memory such as the flash memory module 120 through the IO-expander circuit 115 rather than accessing the flash memory module 120 directly, to limit the number of loads at the single channel NAND bus of the flash memory controller 110 and prevent the DMA speed between the flash memory controller 110 and the flash memory module 120 from being decreased due to increased capacitance corresponding to an increased number of loads.

In Step S11, the flash memory controller 110 can send at least one command (e.g., one or more commands), such as any command among a read command, a write command, etc., from the flash memory controller 110 to the NV memory such as the flash memory module 120 through the IO-expander circuit 115, with the IO-expander circuit 115 being coupled between the flash memory controller 110 and the NV memory such as the flash memory module 120, in order to start performing at least one access operation (e.g., one or more access operations) on the plurality of NV memory elements such as the plurality of flash memory elements 122-1, 122-2 . . . and 122-N via the K channels (e.g., the 16 channels), respectively. When the memory device 100 is designed to having the large capacity corresponding to the large amount of LUNs, in particular, when N=1024, the plurality of flash memory elements 122-1, 122-2 . . . and 122-N may comprise 1024 NAND flash dies.

In Step S12, during performing any access operation among the aforementioned at least one access operation, the flash memory controller 110 can utilize the IO-expander circuit 115 to expand the IO control of the flash memory controller 110 over the NV memory such as the flash memory module 120, for accessing at least one NV memory element corresponding to the aforementioned any sub-channel among the (X*L) sub-channels (e.g., the 16 sub-channels), the (X*L) sub-channels split from any single channel among the K channels under the control of the IO-expander circuit 115.

The aforementioned any sub-channel among the (X*L) sub-channels can be configured for coupling (M/(X*L)) NV memory elements (e.g., (M/(X*L)) NAND flash dies) acting as the (M/(X*L)) loads of this sub-channel, where the aforementioned at least one NV memory element corresponding to the aforementioned any sub-channel belongs to the (M/(X*L)) NV memory elements acting as the (M/(X*L)) loads. In addition, regarding the single channel mentioned in Step S12, X branches of circuits, such as the X branches mentioned above, can be formed with a combination of X 1-to-L interface sub-circuits and all NV memory elements (e.g., the M NAND flash dies) acting as M loads of the X 1-to-L interface sub-circuits, where the aforementioned all NV memory elements (e.g., the M NAND flash dies) acting as the M loads of the X 1-to-L interface sub-circuits comprise the (M/(X*L)) NV memory elements acting as the (M/(X*L)) loads. For brevity, similar descriptions for this embodiment are not repeated in detail here.

For better comprehension, the method may be illustrated with the working flow shown in FIG. 7, but the present invention is not limited thereto. According to some embodiments, one or more steps may be added, deleted, or changed in the working flow shown in FIG. 7. For example, regarding the single channel mentioned in Step S12, the IO-expander circuit comprises at least one 1-to-L interface sub-circuit (e.g., the X 1-to-L interface sub-circuits), and for any 1-to-L interface sub-circuit among the aforementioned at least one 1-to-L interface sub-circuit, during utilizing the IO-expander circuit 115 to expand the IO control of the flash memory controller 110 over the NV memory, the flash memory controller 110 can utilize the two sets of channel buffers 622 within the aforementioned any 1-to-L interface sub-circuit to buffer the information on the single channel, and utilize the two sets of sub-channel buffers 624 within the aforementioned any 1-to-L interface sub-circuit to buffer the information on the L sub-channels among the (X*L) sub-channels, and more particularly, can utilize the set of DEMUX circuits corresponding to the downlink direction to perform demultiplexing on the single channel to obtain the incoming information from the single channel, for being output to the target sub-channel among the L sub-channels, and utilize the set of MUX circuits corresponding to the uplink direction to perform multiplexing on the L sub-channels to obtain the incoming information from the target sub-channel, for being output to the single channel. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing access control of a memory device with aid of expander architecture, the method being at least applicable to a memory controller within the memory device, the memory device comprising the memory controller and a non-volatile (NV) memory, the NV memory comprising a plurality of NV memory elements, the method comprising:
sending at least one command from the memory controller to the NV memory through an input-output-expander (IO-expander) circuit, with the IO-expander circuit being coupled between the memory controller and the NV memory, in order to start performing at least one access operation on the plurality of NV memory elements via multiple channels, respectively; and
during performing any access operation among the at least one access operation, utilizing the IO-expander circuit to expand IO control of the memory controller over the NV memory, for accessing at least one NV memory element corresponding to any sub-channel among a plurality of sub-channels, the plurality of sub-channels split from a single channel among the multiple channels under control of the IO-expander circuit.

2. The method of claim 1, wherein the any sub-channel among the plurality of sub-channels is configured for coupling multiple NV memory elements acting as multiple loads, wherein the at least one NV memory element corresponding to the any sub-channel belongs to the multiple NV memory elements acting as the multiple loads.

3. The method of claim 2, wherein regarding the single channel, multiple branches of circuits are formed with a combination of multiple one-to-many interface sub-circuits and all NV memory elements acting as loads of the multiple one-to-many interface sub-circuits, wherein said all NV memory elements acting as the loads of the multiple one-to-many interface sub-circuits comprise the multiple NV memory elements acting as the multiple loads.

4. The method of claim 1, wherein regarding the single channel, multiple branches of circuits are formed with a combination of multiple one-to-many interface sub-circuits and all NV memory elements acting as loads of the multiple one-to-many interface sub-circuits.

5. The method of claim 1, wherein transferred data between the memory controller and the IO-expander circuit comprises a message but does not include any low-density parity-check (LDPC)-parity, thereby saving transferring overhead at the memory controller.

6. The method of claim 5, further comprising:
offloading LDPC coder and decoder (LDPC-codec) processing into the IO-expander circuit to make the IO-expander circuit handle the LDPC-codec processing regarding the transferred data.

7. The method of claim 1, wherein regarding the single channel, the IO-expander circuit comprises at least one one-to-many interface sub-circuit; and for any one-to-many interface sub-circuit among the at least one one-to-many interface sub-circuit, utilizing the IO-expander circuit to expand IO control of the memory controller over the NV memory further comprises:
utilizing two sets of channel buffers within the any one-to-many interface sub-circuit to buffer information on the single channel, wherein among the two sets of channel buffers, a set of channel buffers corresponding to a downlink direction are arranged to buffer transferred data from the memory controller, and a set of channel buffers corresponding to an uplink direction are arranged to buffer transferred data toward the memory controller; and
utilizing two sets of sub-channel buffers within the any one-to-many interface sub-circuit to buffer information on a set of sub-channels among the plurality of sub-channels, wherein among the two sets of sub-channel buffers, a set of sub-channel buffers corresponding to the downlink direction are arranged to buffer transferred data toward multiple NV memory element groups corresponding to the set of sub-channels, and a set of sub-channel buffers corresponding to the uplink direction are arranged to buffer transferred data from the multiple NV memory element groups corresponding to the set of sub-channels.

8. The method of claim 7, wherein for the any one-to-many interface sub-circuit among the at least one one-to-many interface sub-circuit, utilizing the IO-expander circuit to expand IO control of the memory controller over the NV memory further comprises:
utilizing a set of demultiplexer (DEMUX) circuits corresponding to the downlink direction to perform demultiplexing on the single channel to obtain incoming information from the single channel, for being output to a target sub-channel among the set of sub-channels; and
utilizing a set of multiplexer (MUX) circuits corresponding to the uplink direction to perform multiplexing on the set of sub-channels to obtain incoming information from the target sub-channel, for being output to the single channel.

9. The IO-expander circuit that operates according to the method of claim 1, wherein regarding the single channel, the IO-expander circuit comprises:
at least one one-to-many interface sub-circuit, wherein any one-to-many interface sub-circuit among the at least one one-to-many interface sub-circuit comprises:
two sets of channel buffers, arranged to buffer information on the single channel, wherein among the two sets of channel buffers, a set of channel buffers corresponding to a downlink direction are arranged to buffer transferred data from the memory controller, and a set of channel buffers corresponding to an uplink direction are arranged to buffer transferred data toward the memory controller; and
two sets of sub-channel buffers, arranged to buffer information on a set of sub-channels among the plurality of sub-channels, wherein among the two sets of sub-channel buffers, a set of sub-channel buffers corresponding to the downlink direction are arranged to buffer transferred data toward multiple NV memory element groups corresponding to the set of sub-channels, and a set of sub-channel buffers corresponding to the uplink direction are arranged to buffer transferred data from the multiple NV memory element groups corresponding to the set of sub-channels.

10. The IO-expander circuit of claim 9, wherein the any one-to-many interface sub-circuit among the at least one one-to-many interface sub-circuit further comprises:
a set of demultiplexer (DEMUX) circuits corresponding to the downlink direction, arranged to perform demultiplexing on the single channel to obtain incoming information from the single channel, for being output to a target sub-channel among the set of sub-channels; and
a set of multiplexer (MUX) circuits corresponding to the uplink direction, arranged to perform multiplexing on the set of sub-channels to obtain incoming information from the target sub-channel, for being output to the single channel.

11. The IO-expander circuit of claim 9, wherein regarding the single channel, a branch of circuits is formed with a combination of the any one-to-many interface sub-circuit within the IO-expander circuit and all NV memory elements acting as loads of the any one-to-many interface sub-circuit.

12. A memory controller, for performing access control of a memory device with aid of expander architecture, the memory device comprising the memory controller and a non-volatile (NV) memory, the NV memory comprising at least one NV memory element, the memory controller comprising:
a processing circuit, arranged to control the memory controller according to a plurality of host commands from a host device, to allow the host device to access the NV memory through the memory controller;
wherein:
the memory controller is arranged to send at least one command from the memory controller to the NV memory through an input-output-expander (IO-expander) circuit, with the IO-expander circuit being coupled between the memory controller and the NV memory, in order to start performing at least one access operation on the plurality of NV memory elements via multiple channels, respectively; and
during performing any access operation among the at least one access operation, the memory controller is arranged to utilize the IO-expander circuit to expand IO control of the memory controller over the NV memory, for accessing at least one NV memory element corresponding to any sub-channel among a plurality of sub-channels, the plurality of sub-channels split from a single channel among the multiple channels under control of the IO-expander circuit.

13. The memory device comprising the memory controller of claim 12, wherein the memory device comprises:
the NV memory, configured to store information;
the memory controller, configured to control operations of the memory device; and
the IO-expander circuit, coupled between the memory controller and the NV memory, configured to expand the IO control of the memory controller over the NV memory.

14. The electronic device comprising the memory device of claim 13, and further comprising:
the host device, coupled to the memory device, wherein the host device comprises:
at least one processor, arranged for controlling operations of the host device; and
a power supply circuit, coupled to the at least one processor, arranged for providing power to the at least one processor and the memory device;
wherein the memory device provides the host device with storage space.
